(19) United States
(12) Patent Application Publication
(10) Pub. No.: US 2024/0183169 A1
(43) Pub. Date: Jun. 6, 2024

(54) Composite Overclad Panels for Buildings

(71) Applicant: UT-Battelle, LLC, Oak Ridge, TN (US)

(72) Inventors: Nolan W. Hayes, Jefferson City, TN (US); Diana Hun, Lenoir City, TN (US); Pritesh Yeole, Knoxville, TN (US); Uday Vaidya, Knoxville, TN (US)

(21) Appl. No.: 18/375,104

(22) Filed: Sep. 29, 2023

Related U.S. Application Data
(60) Provisional application No. 63/430,268, filed on Dec. 5, 2022.

(51) Int. Cl. E04F 13/08; B32B 3/06; B32B 5/02; B32B 5/26; B32B 7/12; B32B 37/12; B32B 37/18; E04B 1/94

(52) U.S. Cl. CPC E04F 13/0876; B32B 3/06; B32B 5/02; B32B 5/26; B32B 7/12; B32B 37/12; B32B 37/18; E04B 1/947; E04F 13/083; E04F 13/0894; B32B 2260/023; B32B 2260/025; B32B 2260/046; B32B 2262/101; B32B 2264/203; B32B 2305/076; B32B 2307/3065; B32B 2607/00

(57) ABSTRACT

The disclosure provides systems methods for overclad panels for buildings. The overclad panels include a first fiber sheet, a second fiber sheet and a plurality of foam beams arranged parallel to one another and disposed between the first fiber sheet and the second fiber sheet. The first fiber sheet, second fiber sheet, and plurality of foam beams can be bonded together with resin. The panels can further include an aesthetic textile layer and a Teflon barrier layer.

### CLAIM OF PRIORITY

This application claims priority to U.S. Provisional Appl. No. 63/430,268 filed on Dec. 5, 2022, the disclosure of which is incorporated herein by reference in its entirety.

### STATEMENT REGARDING FEDERALLY SPONSORED RESEARCH OR DEVELOPMENT

This invention was made with the United States Government support under grant numbers DE-AC05-00OR22725 awarded by the US Department of Energy. The United States Government has certain rights in the invention.

### FIELD OF THE DISCLOSURE

The present disclosure generally relates to devices and methods for building cladding and to systems, assemblies, methods and uses for such a product.

### BACKGROUND OF THE DISCLOSURE

Many existing buildings (including office buildings, commercial buildings, homes, garages, and other building structures) worldwide were built before the introduction of energy codes. Thus, a large number of buildings lack proper insulation and sealing, which leads to increases in energy usage (and corresponding carbon output). Overclad panels can be used to provide additional insulation and sealing to existing buildings, but conventional overclad panels suffer from several deficiencies. For example, conventional solutions use traditional building materials and assembly techniques that lead to unoptimized designs that require lengthy installation procedures, are expensive, and are prone to installation errors. Conventional solutions are also limited in application and do not permit the installation of an airtight and watertight panel-to-opening interface (e.g., interface with a window or other opening).

The current disclosure describes devices and methods directed towards solving one or more of the issues described above.

### SUMMARY OF THE DISCLOSURE

Disclosed scenarios provide composite overclad panels for buildings and methods for creation and usage thereof. For example, some of the disclosed scenarios include an overclad panel including a first fiber sheet, a second fiber sheet, and a plurality of foam beams arranged parallel to one another and disposed between the first fiber sheet and the second fiber sheet. The overclad panel can further include a textile layer. The plurality of foam beams can contact a first surface of the first fiber sheet; and the textile layer can be disposed on a second surface of the first fiber sheet.

In some embodiments, the overclad panel can further include a barrier layer disposed on a surface of at least one of the first fiber sheet or the second fiber sheet. The first fiber sheet, second fiber sheet, and plurality of foam beams can be bonded together with resin. The first fiber sheet, second fiber sheet, and plurality of foam beams can be bonded using vacuum assisted resin transfer molding. In further embodiments, the overclad panel can further include an intumescent material.

In some embodiments, the overclad panel can include two or more blocks that interleave with each other, each of the two or more blocks comprising at least one of the foam beams. The plurality of foam beams can include a first set of trapezoidal cross-section foam beams arranged parallel to each other such that their respective wider bases are in contact to the first fiber sheet and their respective narrower bases are in contact to the second fiber sheet, and a second set of trapezoidal cross-section foam beams arranged parallel to each other such that their respective wider bases are in contact to the second fiber sheet and their respective narrower bases are in contact to the first fiber sheet, wherein the trapezoidal cross-section foam beams of the second set are nested between the trapezoidal cross-section foam beams of the first set such that side surfaces of the trapezoidal cross-section foam beams of the second set are in contact with side surfaces of the trapezoidal cross-section foam beams of the first set.

Another scenario includes an overclad panel system including two or more panels, each panel including a first fiber sheet and a second fiber sheet, and at least one foam beam. The overclad panel system can further include panel-to-building connections configured to couple the panels to a building wall, wherein each panel-to-building connection includes a first panel-to-building connector having a panel cleat disposed on a surface of an associated panel that is to face the building wall, and a second panel-to-building connector having a wall cleat configured to be disposed on the building wall and arranged relative to the panel cleat to engage with the panel cleat. The at least one foam beam can be a first set of trapezoidal cross-section foam beams arranged parallel to each other such that their respective wider bases are in contact to the first fiber sheet and their respective narrower bases are in contact to the second fiber sheet, and a second set of trapezoidal cross-section foam beams arranged parallel to each other such that their respective wider bases are in contact to the second fiber sheet and their respective narrower bases are in contact to the first fiber sheet, wherein the trapezoidal cross-section foam beams of the second set are nested between the trapezoidal cross-section foam beams of the first set such that side surfaces of the trapezoidal cross-section foam beams of the second set are in contact with side surfaces of the trapezoidal cross-section foam beams of the first set.

In some embodiments, the overclad panel system further includes panel-to-panel connections configured to couple panels along a common edge when the panels are coupled to the building wall, wherein each panel-to-panel connection includes a first panel-to-panel connector having a protrusion disposed on the common edge of one of an associated pair of panels, and a second panel-to-panel connector having a groove disposed on the common edge of the other one of the associated pair of panels configured to engage the protrusion.

The first and second panel-to-panel connectors can be fiber reinforced polymer components. The fiber reinforced polymer components can be formed into their respective panels. The first and second panel-to-building connectors can be fiber reinforced polymer components. The first panel-to-building connector can be fastened to the associated panel. The second panel-to-building connector can be fastened to the building wall.

In some embodiments, at least one of the two or more panels further includes a window aperture. The overclad panel system can further include a window comprising a frame, a window-to-panel connection including: a first window-to-panel connector including window frame cleat disposed on the frame; and a second window-to-panel connector comprising panel window cleat disposed within the aperture. The window frame cleat can be configured to engage the panel window cleat to secure the window within the aperture.

In yet another scenario, a method of constructing an overclad panel is provided. The method can include placing at least one first foam beam on a first fiber layer, placing a second fiber layer over the first foam beam, placing distribution media on the second fiber layer, and infusing the first fiber layer, second fiber layer, and first foam beam with resin. The method can further include placing at least second foam beam on a third fiber layer, placing a fourth fiber layer over the second foam beam, placing distribution media on the fourth fiber layer, infusing the third fiber layer, fourth fiber layer, and second foam beam with resin, and adhering the resin infused first fiber layer, second fiber layer, and first foam beam to the resin infused third fiber layer, fourth fiber layer, and second foam beam to form a composite panel.

### BRIEF DESCRIPTION OF THE DRAWINGS

FIG. 1 is a perspective view of a building wall with example composite overclad panels installed.

FIG. 2 is a cross sectional view of a building wall with example composite overclad panels installed.

FIG. 3A is a cross sectional exploded view of an example composite overclad panel.

FIG. 3B is a cross sectional assembled view of an example composite overclad panel.

FIG. 4 is a cross sectional view of an example composite overclad panel.

FIG. 5 illustrates an example composite overclad panel with panel connections separated from the overclad panel.

FIG. 6A is a perspective cross sectional view of two example composite overclad panels.

FIG. 6B is a perspective cross sectional view of an example panel connection between two example composite overclad panels.

FIG. 6C is a cross sectional view of an example panel connection between two example composite overclad panels.

FIG. 6D is a cross sectional view of an example corner panel connector.

FIG. 6E is a perspective view of the example corner panel connector of FIG. 6D.

FIG. 7A is an illustration showing perspective views of installation of a window in an example composite overclad panel.

FIG. 7B is an illustration showing cross sectional views of installation of a window in an example composite overclad panel.

FIG. 7C is a cross sectional view of an example connection between an example composite overclad panel and a window.

FIG. 8A is a cross sectional views of a building wall and an example composite overclad panel before installation.

FIG. 8B is a cross sectional views of a building wall and an example composite overclad panel installed showing a panel to wall connection.

FIG. 9A is a perspective view of a building wall.

FIG. 9B is a perspective view of a building wall with wall side panel to wall connections installed.

FIG. 9C is a perspective view of a building wall with an example composite overclad panel installed.

FIG. 9D is a perspective view of a building wall with two example composite overclad panels installed.

FIG. 9E is a perspective view of a building wall with three example composite overclad panels installed.

FIG. 9F is a perspective view of a building wall with three example composite overclad panels installed illustrating installation of a window.

FIG. 9G is a perspective view of a building wall with three example composite overclad panels and a window installed.

FIG. 9H is a perspective view of a building wall with four example composite overclad panels installed.

FIG. 9I is a perspective view of a building wall with five example composite overclad panels installed.

FIG. 9J is a perspective view of a building wall with six example composite overclad panels installed.

FIG. 10 is a flowchart illustrating an example method for constructing a composite overclad panel.

### BRIEF DESCRIPTION OF DISCLOSED EMBODIMENTS

The devices and methods of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. In some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, proximal, distal, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

As used herein, an “overclad panel” refers to an addition to a building structure that changes mechanical and/or aesthetic properties of the building, such as but not limited to structural strength, stability, insulating value, weatherproofing, soundproofing, and appearance.

As used herein, a “retrofit” refers to one or more overclad panels that are installed on a building after the initial construction of the building. Put differently, “retrofitting” refers to adding panels to a building that did not include the panels when the building was constructed. For example, a building can have a retrofit overclad panel system installed many years after the building was initially constructed to help protect the original exterior of the building, add structural integrity, improve the building's insulation, etc. While the overclad panel system disclosed in this document can be used as a retrofit, they are not limited as such. For example, in some implementations the panels of this disclosure could be used during the initial construction of a new building.

Many buildings in the United States and elsewhere across the world were constructed before energy code requirements were in place. In order to reduce the energy consumption of buildings, there is a need to develop quick, reliable, and/or cost-effective solutions for building envelope retrofits to meet decarbonization goals, improve insulation, improve aesthetics, or for other applications. Currently existing building retrofits using overclad panels typically use traditional building materials and assembly techniques that lead to unoptimized designs inhibiting affordability, aesthetic creativity, and speed of assembly. Conventional systems also suffer from moisture durability problems, especially if moisture enters a space between the existing outer surface of the building and the interior of the overclad retrofit. Disclosed devices and techniques provide a prefabricated, modular, fiber-reinforced composite, overclad panel system as a cost-effective and easy-to-install retrofit technology. Overclad panels using premanufactured components have the potential to expedite installation and minimize disruption to building occupants. Additionally, overclad panels can be used to enhance aesthetics and increase property value, while also providing protection against weather elements (e.g., moisture) and additional insulation to the existing building. In some cases, disclosed overclad panels can be constructed to be loadbearing to increase the structural rigidity and stability of an existing building. Additionally, the disclosed overclad panels can be manufactured with and/include flame-retardant materials or other post-finish treatments adding to the aesthetics and sealing properties of the retrofit. The disclosed overclad panels can be easily scaled and manufactured for mass production and customization.

Disclosed devices, assemblies, and methods also include air and watertight connections for installing the overclad panels onto building walls (or other structures) that can expedite and improve the quality of installation. While the devices and techniques disclosed herein are described with respect to a “building” wall, it is understood that the devices and techniques may in suitable circumstances be applied to any type of structure including but not limited to office buildings, commercial buildings, single family houses, multi-unit houses, row houses, townhouses, apartment or condo complexes, Quonset huts, barns, garages, sheds, storage buildings or other storage units, shipping containers, etc.

In various implementations, the current disclosure describes a composite overclad panel for retrofitting to an existing building. The disclosed overclad panel system can be constructed to meet building code requirements (i.e., the general requirements for exterior wall covering including specifications for structural, water, air, and fire resistance), for example the International Residential Code (IRC) and the International Building Code (IBC) where applicable. The disclosed panels can be constructed to resist superimposed structural loads including wind and seismic forces. For example, the disclosed panel can be configured and tested to meet failure and deflection criteria under predicted load conditions. The overclad panel can be formed of a plurality of preformed composite foam structures (foam beams) that are assembled together and with fiber sheets. The assembly is injected with resin to create a composite overclad panel that is fiber reinforced. The foam beams serve as insulation for the overclad panel. The exterior of the panel can include a Teflon or similar layer or layers to provide air and water resistance. Optionally, an aesthetic textile layer can be placed between the Teflon barrier and the fiber reinforced foam beams to provide a desired appearance to the overclad panel. Optionally, the overclad panels can include and/or be coupled to various connectors used for retrofit installation of the overclad panels on an existing building. Example connectors can include panel-to-panel connectors, wall-to-panel connectors, and panel-to-window connectors.

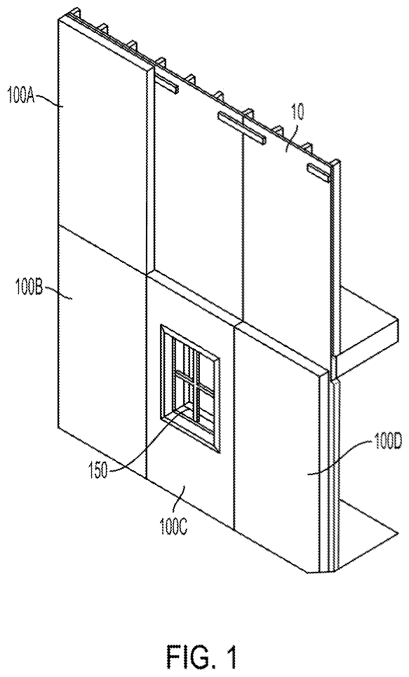

Referring now to the drawings, and in particular to FIGS. 1-5, an example composite overclad panel 100 is shown and described. Overclad panels 100 can be installed as a retrofit on an existing wall 10. As shown in FIG. 1, a plurality of overclad panels 100A-D (collectively, 100) can be installed on a single existing wall 10. Overclad panels 100 can be manufactured in a variety of sizes (and in some cases shapes) depending on the size and style of the walls to be fitted with the panels. In some embodiments, panels 100 can include apertures for windows 150 as shown with respect to panel 100C. In the specific example of FIG. 1, wall 10 has four installed panels 100A-D, however, any number of panels are within the scope of this disclosure.

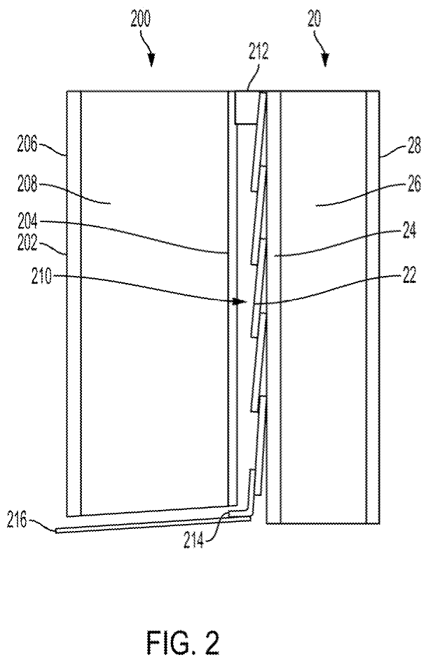

FIG. 2 is a cross sectional view of a building wall 20 with overclad panel 200 installed. Panel 200 can correspond to panels 100, as described with respect to FIG. 1. As shown in FIG. 2, the overclad panel 200 can include a fiber reinforced polymer 208 sandwiched between insulating barrier(s) 202, 204.

Panel 200 can include an insulating barrier 202, 204 (such as Teflon, polyethylene membrane, polyolefin membrane, or other suitable material) on each of the large sides of the overclad panel (i.e., the side facing wall 20 and the side facing away from wall 20). The insulating barrier may provide properties such as air insulation, water insulation, sound insulation, or the like to the building wall 20.

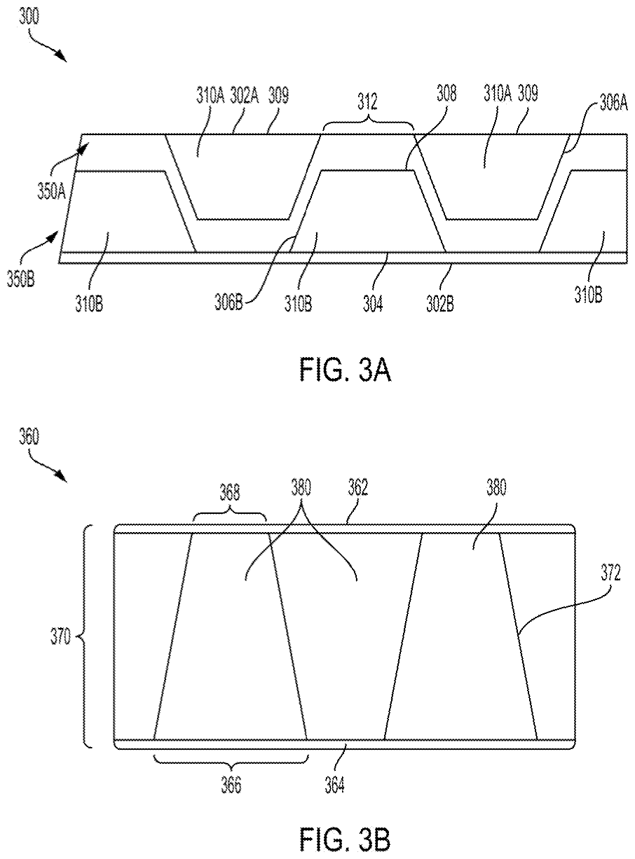

Overclad panel 200 can further include a cladding or textile layer 206 to provide a desired appearance to the exterior of the overclad panel 200 when it is installed. For example, the textile layer can be a fabric that has a particular color or appearance such as brick, stone, stucco, wood grain, or other design. For example, this appearance can give the retrofitted building the illusion of being made of brick or another material, despite being covered with the composite overclad panels 200. The textile 206 can be sandwiched between the insulating barrier and an inner layer of fiber reinforced polymer 208 on the inside of overclad panel 200. Accordingly, overclad panel 200 can further include fiber reinforced polymer 208 on its interior. Fiber reinforced polymer 208 can take the form of one or foam beams that are reinforced with fiber layers and injected with resin, as described in greater detail below with respect to, for example, FIGS. 3, 4, and 11. In some embodiments, panel 200 may not include a textile layer 206. In such cases, a paint layer can be used between the insulating barrier layer and the first layer of fiber of the fiber reinforced insulation layer 208. The paint can provide a desired colored appearance to the outward facing surface of panel 200. In other implementations, paint can be applied to the exterior of preconstructed panels 200 (i.e., over the insulating barrier layer 202) before or after panels 200 are installed.

Overclad panels 200 can be installed on existing building wall 20 with a drainage gap 210 between overclad panel 200 and wall 20. The drainage gap may be created by, for example, providing a gasket 212 around or proximate a perimeter of the overclad panel. The size of the drainage gap 210 can vary based on the particular installation and/or application. For example, the size may be about ¼ inch to about ¾ inch, about ⅛ inch to about ⅞ inch, about ⅓ inch to about ⅚ inch, about ½ inch to about 1 inch, or the like. Other sizes may be possible, based on the size of gasket 212 and the thickness of panel-to-wall connectors, which are described in greater detail below. A gasket 212 can be placed between overclad panel 200 and wall 20 to limit the amount moisture that can enter drainage gap 210. In various implementations, gasket 212 can be placed around an entire individual panel 200 or around the around outer perimeter of a plurality of installed panels. In some instances, gaskets may not be required between panels 200 because of the usage of watertight panel-to-panel connectors. Optionally, in some embodiments, flashing 214 can be placed at or near the bottom of gap 210 along the bottom most series of panels 200 relative to wall 20 (e.g., panels 100B, 100C, 100D of FIG. 1) and be provided with drainage holes 116 along its length to permit moisture that does enter gap 110 to drain out at or near the bottom of the overclad panel. This drainage system can prevent unwanted deterioration of wall 10, and limit the formation of mold and mildew on the surfaces of wall 20 and overclad panel 200 that face each other.

Wall 20 can be any existing building wall and may have a variety of constructions. FIG. 2 illustrates one such construction in which the wall 20 includes siding 22 placed over sheathing layer 24. Behind sheathing layer 24, wall 20 may or may not include insulation 26 and drywall layer 28. The disclosed embodiments are not limited to use with a particular type of existing wall construction. For example, wall 20 could be constructed of brick, logs or other wood, wood siding, vinyl siding, composite siding, concrete, stone, metal, etc.

FIG. 3A is a cross sectional exploded view of an example composite overclad panel 300, which in some embodiments may correspond to panels 100, 200 described above. Panel 300 includes two complementary blocks 350A, 350B that are coupled together. It should be noted that while the disclosure describes the use of two complementary blocks, it is not so limiting, and more than two blocks may be used to form a panel 300 (e.g., two complementary smaller panels coupled to one large panel). In some embodiments, the two blocks 150A, 150B can be constructed separately, then connected or coupled together using, for example, an adhesive 208 placed on the inner facing surfaces of the two halve panels 150A, 150B. Examples of adhesive can include, without limitation, a polyurethane adhesive, epoxy adhesive, cyanoacrylate adhesive, acrylic adhesive, or other suitable adhesives. Other coupling mechanisms such as fasteners like bolts or screws, an adhesive tape, rivets, pins, or other suitable mechanisms are within the scope of this disclosure. The two blocks can have generally the same construction as described below, while being mirror images of each other such that they can fit together as shown to form a single uniform panel. Additionally, in some embodiments, panel blocks 350A, 150B can differ in that one of the panels blocks 350A, 350B can include a textile layer 304 or other layer (e.g., an aesthetic enhancing layer, a mechanical property enhancing layer etc.) to give the one side of the completed panel 300 a particular appearance or property.

Each of the panel blocks 350A, 350B can include a plurality of foam beams 310 that interlock with each other when the blocks 350A, 350B are coupled together. Foam beams 310 can be made from a polyisocyanurate rigid foam, expanded polystyrene rigid foam, extruded polystyrene rigid foam, or other suitable closed cell foam insulation material.

Referring back to FIG. 3A, each of the panel blocks 350A, 350B can be formed to include multiple foam beams 310 sandwiched between two layers of fiber reinforced laminates. Specifically, as shown in FIG. 3, panel block 350A includes foam beams 310A sandwiched between laminate layers 302A and 306A, and panel block 350B includes foam beams 310B sandwiched between laminate layers 302B and 306B. As such, the laminate layer 302 is planar while laminate layer 306 forms peaks and valleys over the foam beams of a particular block. The fiber reinforced laminates can be fiber sheets 302, 306 (e.g., fiber sheets) placed on either side of the foam beams. Accordingly, the panel can include a plurality of foam beams arranged parallel to one another and disposed between a first fiber sheet and a second fiber sheet. The fiber sheets and beams can them be injected with resin to form a single piece composite panel block. The resin binds the components of the panels blocks together. Additionally, the resin is airtight, watertight, and resistant to UV light, and its translucent formulation does not affect the visibility of the textile 304. The process used to form the panel blocks and resin injection are described in greater detail below, particularly with respect to FIG. 11.

Referring to FIGS. 3A and 3B, the foam beams can be preformed to particular size and shape based on the insulation requirements and strength requirement of the desired panel 300, 360. For example, foam beams can have a trapezoidal cross section as illustrated, or can have other cross-sectional shapes, such as triangles, semi-circles, wave-form, and rectangles. The beams on each of the blocks can be positioned or spaced such that beams on one panel block can fit between the beams on the corresponding panel block. Accordingly, the gap 312 between the base 309 of the beams of block 350A is approximately the same as the narrow end width 308 of beams 310B of block 350B. The number and spacing of the beams 310A of block 350A can correspond to the number and spacing of the beams 310B of block 350B such that the beams are interleaved (as shown in e.g., FIG. 3B) when blocks 350A, 350B are brought together with the beams each block fitting between the beams of other block.

FIG. 3B illustrates an overclad panel 360 in an assembled form having interleaved beams 380. Beams 380 can also include wide end width 366 and a thickness 370. These three dimensions (wide end width 366, narrow end width 368, and thickness 370) can be adjusted based on the load and insulation requirements of the particular desired panel. For example, if a panel with greater insulating capabilities is required, the thickness 370 can be increased.

Accordingly, the completed panel 360 can include a first set of trapezoidal cross-section foam beams arranged parallel to each other such that their respective wider bases (i.e., dimension 366) are in contact to the first fiber sheet and their respective narrower bases (i.e., dimension 368) are in contact to the second fiber sheet. The panel 360 can further include a second set of trapezoidal cross-section foam beams arranged parallel to each other such that their respective wider bases are in contact to the second fiber sheet and their respective narrower bases are in contact to the first fiber sheet, wherein the trapezoidal cross-section foam beams of the second set are nested between the trapezoidal cross-section foam beams of the first set such that side surfaces of the trapezoidal cross-section foam beams of the second set are in contact with side surfaces of the trapezoidal cross-section foam beams of the first set, as depicted in FIG. 3B.

Referring back to FIG. 3A, each of the fiber sheets may comprise a plurality of fibers that are woven, nonwoven, continuous, chopped, and/or a combination thereof. The fibers may, optionally, be bound together with a heat cured binder, such as known resinous phenolic materials, like phenolformaldehyde resins or phenol urea formaldehyde (PUFA). Melamine formaldehyde, acrylic, polyester, urethane and furan binder may also be utilized in some embodiments. Examples of such fibers can include, without limitation, organic fibers such as polymeric fibers, carbon fibers, cellulose fibers, or inorganic fibers such as rotary glass fibers, textile glass fibers, acrylic, polyester, nylon, aramid, stonewool (also known as rockwool), or a combination thereof. Mineral fibers, such as glass, are preferred. The preferred fiber sheet can be used alone or in combination with other types of fibers such as carbon fibers, steel fibers or other polymer fibers. The structural capacity of overclad panels 300 can significantly altered by changing the thickness, tensile strength, fiber density, layout, and/or orientation of the fibers in one or both of the fiber sheets 302, 306. For example, to construct a lighter overclad panel with less strength, fiber sheets with low fiber density and unidirectional fibers could be used. If a stronger overclad panel is desired (for example, in situations with a high expected wind load or where seismic activity is likely), fiber sheets having a higher fiber density and/or multi-directional fibers (e.g., randomly oriented or perpendicularly oriented fibers) could be used. Accordingly, properties of overclad panels 300 (such as strength, weight, and insulation value) can be specifically tailored to a certain use case. Additionally, the strength and weight of the overclad panels 300 can be tailored without changing the size of foam beams 310, simply by altering the makeup of fiber sheets 302, 306.

In some embodiments, panel 300 can further include an intumescent material. For example, an intumescent coating or other type of fire-resistant coating can be applied to one or more of sides of the overclad panel (for example, the side facing the building wall when installed and/or the side facing away from the building wall) to increase the fire resistance of the panel. Other types of coatings such as, without limitation, paint with and without color, ceramic coating with and without color are within the scope of this disclosure.

Total overclad panel thickness can range from 0.5 to 10 inches or more. The fiber reinforced polymer laminates can be formed for varying tensile strength ranging from approximately 40,000 to 150,000 pounds per square inch or more dependent on the mechanical characteristics of constituent materials, manufacturing methods, proportion of fibers and matrix materials, and orientation of fibers through matrix. Overclad panels can be specifically designed to resist applied loads on the face varying from 10 to 100 pounds per square foot or more dependent on laminate strength, panel thickness, and internal structure.

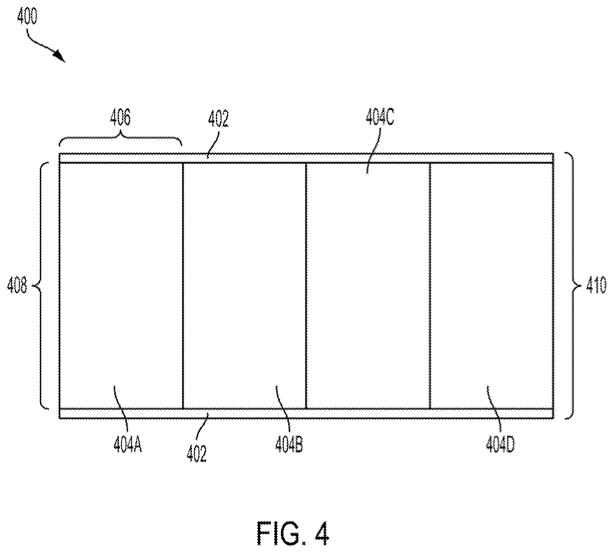

FIG. 4 is a cross sectional view of an alternative example composite overclad panel 400. As illustrated, overclad panel 400 can include rectangular foam beams 404A-D having a width 406 and a thickness 408. Rectangular foam beams 404A-D can be sandwiched between fiber sheets 402. In some embodiments, overclad panel 400 can be formed as one unit with all foams beams 404A-D at the same time (i.e., all the beams can be injected with resin at the same time. In other embodiments, panel 400 can be formed from one or more blocks, substantially as described above with respect to blocks 350A, 350B of FIG. 3A. For example, foam beams 404A and 404C could be formed into one block and beams 404B, 404D could be formed into another block, with are then connected as described above. Beams 404A, 404C can be interleaved with beams 404B, 404D.

The various panels described in this disclosure can further include a variety of connectors to connect panels to other panels, panels to walls, and panels to openings such as windows. Each of the various connectors below can be made from fiber reinforced polymer components (similar to the panel blocks discussed above and cut and shaped to obtain a desired connection). The connectors can be formed using pultrusion and cut to a desired length. Various connectors can be used in corresponding pairs to form connections between two panels, between panels and walls, and between panels and openings.

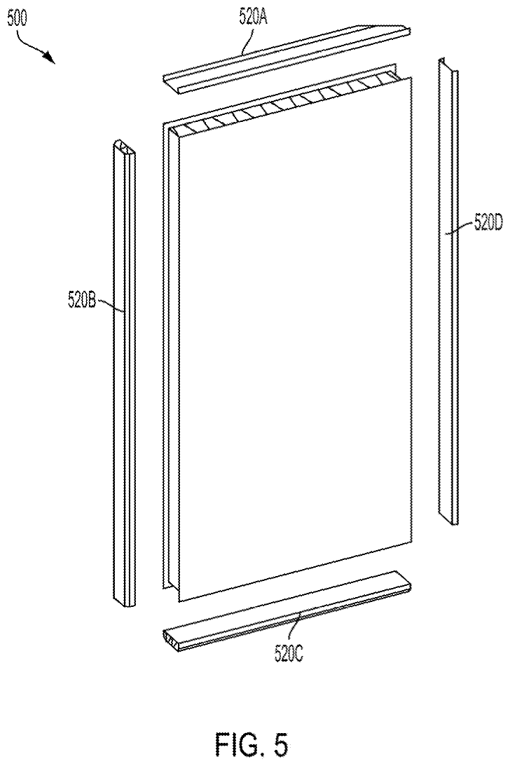

FIG. 5 illustrates an exploded view of an example composite overclad panel with panel-to-panel connectors 520A-D that are integrally formed and/or otherwise provided along the perimeter the overclad panel 500. Panel connectors 520A-D are depicted as being separate from panel 500. However, the panel-to-panel connectors 520A-D can be formed into panel 500. In other embodiments, panel-to-panel connectors 520A-D can be fastened to panel 500 using fasteners (e.g., screws, bolts, rivets, pins, or the like) or an adhesive such as a suitable glue or tape. Panel-to-panel connectors 520A-D can form tongue and groove style (or similar style connections) having a protrusion and a corresponding groove into which the protrusion is sized and shaped to engage. Accordingly, panel 500 can include panel-to-panel connectors 520A-D configured to couple panels along a common edge when the panels are coupled to the building wall. Each panel-to-panel connection comprises: a protrusion disposed on the common edge of one of an associated pair of panels, and a groove disposed on the common edge of the other one of the associated pair of panels configured to engage the groove. As illustrated in FIG. 5, connectors 520B, 520C include a protrusion and connectors 520A, 520D include a corresponding groove. Preferably, a connector including a protrusion would be installed on opposite side of a panel from a connector including a groove such that a plurality of identical panels could be installed in series on a wall.

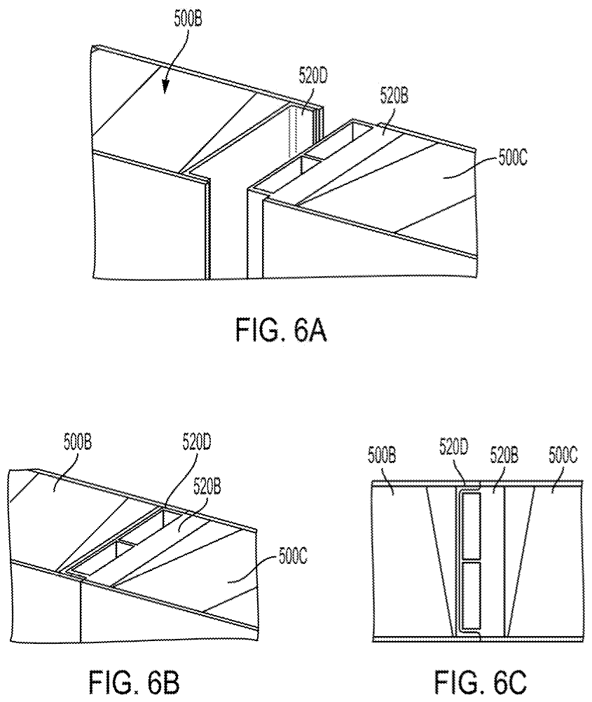

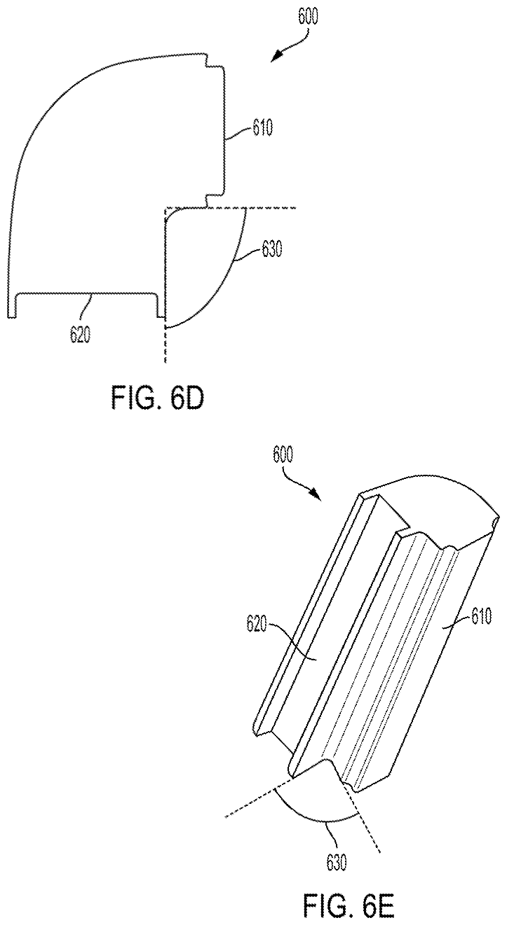

FIG. 6CB is a cross sectional view of an example panel-to-panel connection between two example composite overclad panels 500B, 500C. As illustrated by FIG. 6C, the protrusion of connector 520B can engage with the groove of connector 520D to connect panels 500B, 500C together. FIG. 6A is a perspective cross sectional view of two example composite overclad panels that illustrates two adjacent panels before connection of the corresponding panel-to-panel connectors 520B, 520D. FIG. 6B is a perspective cross sectional view of an example panel-to-panel connection between two example composite overclad panels.

Panel-to-panel connectors can also include corner panel-to-panel connectors that facilitate connection between two panels at an angle other than 180 degrees. Corner connectors could be similar to panel-to-panel connectors 520B and 520D, where one or both of the connectors is extend and bent at a desired angle to permit panels 500B, 500C to form an angle relative to one another.

FIG. 6D is a cross sectional view of another style of corner connector 600 than could be used with panel-to-panel connectors 520B, 520D. FIG. 6E is a perspective view of corner connector 600. Corner connector 600 can include tongue and groove portions that engage corresponding portions of panel-to-panel connectors (e.g., panel-to-panel connectors 520B and 520D). For example, projection 610 can engage the groove of 520D of a first panel, and groove 620 can engage projection of 520B of a second panel to connect the two panels together. Using this three-piece design for corner connections permits identical panels 500B, 500C to be used with integrated panel-to-panel connections to form a corner or an angle. The degree of the angle 630 can be changed by changing out the corner connector 600, which can be manufactured to varying angles. This permits all identical panels to be manufactured without requiring special panels for corners, which can reduce make installation easier, reduce the total number of various parts required, and limit installation errors.

The material, sizes, and dimensions of connectors can be chosen to ensure a water and airtight fit between panels. Additionally, the use of these connectors (and the other panel-to-wall and panel-to-window connectors described below), reduces the number of required unique parts and fasteners for installing a retrofit overclad can be greatly reduced. Additionally, these connectors can increase the ease of use and installation of such retrofits, thereby reducing the speed of installation and lowering the instances of installation errors.

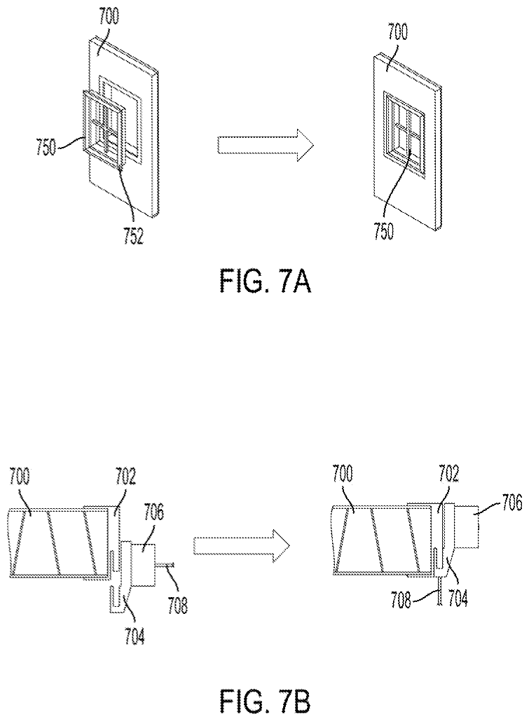

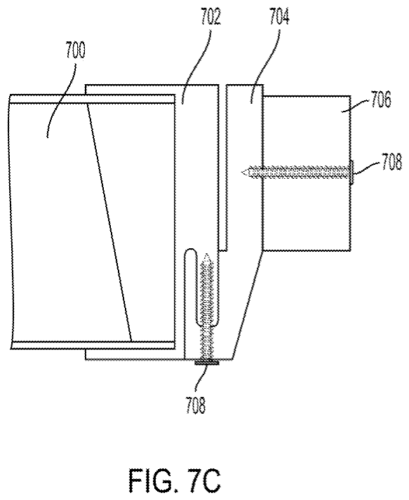

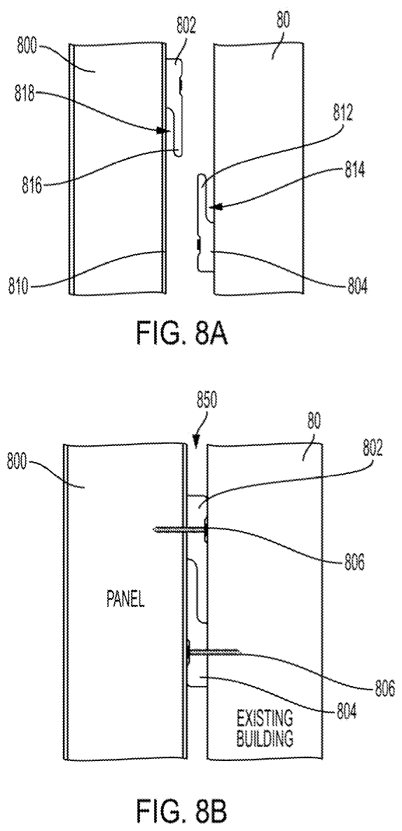

In addition to panel-to-panel connectors, disclosed embodiments provide solutions for attaching panels to window frames (or other opening frames, including but not limited to door frames, vent frames, frames around utility connections, etc.). As illustrated in FIGS. 7A-7C, in some embodiments, panels 700 can include apertures 755. Apertures 755 can be pre-formed in panels 700. In other instances, aperture 755 can be cut into panel 700. A window 750 including a frame 752 can be inserted into aperture 755. Window 750 can be attached to panel 700 within aperture 755 through window-to-panel connectors. The window to panel connectors can include a window frame cleat 704 disposed on the frame 752 and a panel window cleat 702 disposed within the aperture and attached to the panel 700. The window frame cleat 704 is configured to engage the panel window cleat 702 to secure the window within the aperture 755. For example, each of the window frame cleat 704 panel window cleat 702 can include corresponding tongue and groove connections designed to engage together, as depicted in FIG. 7. The panel window cleat 702 can be formed into panel 700 or otherwise fastened. The window frame cleat 704 can be fastened to a portion 706 of window frame 752 using a fastener 708. The window frame cleat 704 can extend around the entire perimeter of window frame 752. For example, four pieces of window frame cleat 704 can be used, with one being fastened to each side of window 750. Similarly, four pieces of panel window cleat 702 can be installed around aperture 755. Accordingly, a full seal can be achieved between panel 100 and window 750 around the entire perimeter of window 750. As shown in FIG. 7, one or more fasteners 708 can be placed such that it is extending through both panel window cleat 702 and window frame cleat 704 to securing attach window 750 to panel 700.

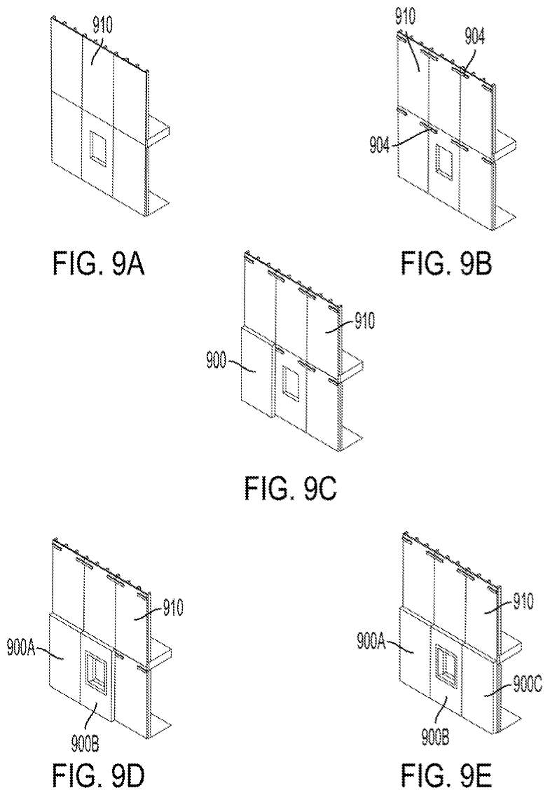

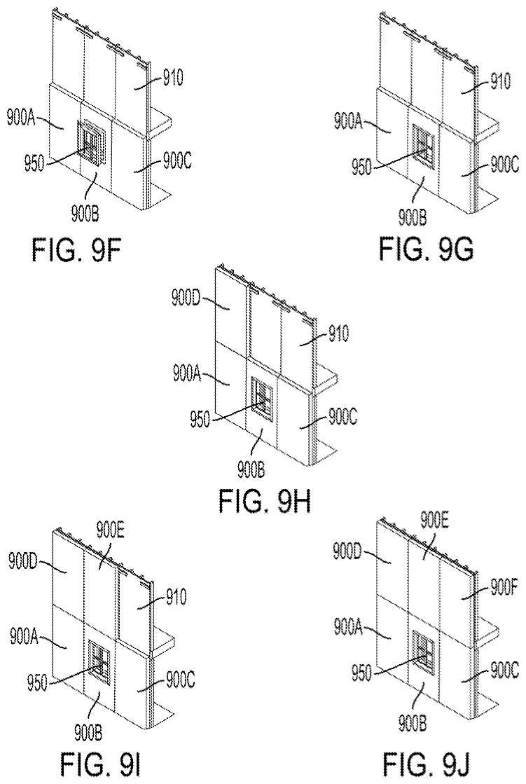

Disclosed devices also include panel-to-building connectors configured to couple the panels 800 to a building wall 80. Panel-to-building connectors include panel cleat 802 disposed on an inner surface 810 of an associated panel 800 that is to face the building wall 80. Panel-to-building connectors also include a wall cleat 804 disposed on the building wall 80 and arranged relative to the panel cleat 802 to form a cleat connection with the panel cleat 802. Wall cleat 804 can be fastened to wall 10 using a fastener 806 and can include an upward extending protrusion 812. A gap 814 can be formed between wall 80 and upward extending protrusion 812. Panel cleat 802 can be fastened to panel 800 using a fastener 806 and can include a corresponding downward extending protrusion 816. A gap 818 can be formed between panel 800 and downward extending protrusion 816. The protrusions and gaps can be sized and shaped such that upward extending protrusion 812 extends into gap 818 and downward extending protrusion 816 extends into gap 814, as shown in FIG. 9B. In other words, panel cleat 802 and wall cleat 804 can be configured to engage each other and hold panel 800 on to wall 80. By using a downward facing configuration for panel cleat 802, gravity can assist in holding panel 800 to wall 80.

Disclosed embodiments include an overclad panel system including disclosed components including one or more of the following: panels 100, 200, 300, 400, 500, 600, 700, 800, 900, panel-to-building connectors, panel-to-panel connectors, and panel-to-window connectors. The overclad panel system can further include one or more gaskets and one or more pieces of flashing, as described above.

FIGS. 9A-9J illustrate an example progression of installation of a plurality of overclad panels 900 on a building wall 910. FIG. 9A is a perspective view of a preexisting building wall 910. FIG. 9B is a perspective view of building wall 910 with wall side panel-to-wall connectors 904 installed. FIG. 9C is a perspective view of building wall 910 with an example composite overclad panel 900 installed on one portion of the wall. FIG. 9D is a perspective view of building wall 910 with two example overclad panels 900A, 900B installed. FIG. 9E is a perspective view of building wall 910 with three overclad panels 900A, 900B, 900C installed. FIG. 9F is a perspective view of building wall 910 with three overclad panels 900A, 900B, 900C installed, further illustrating installation of a window 950. FIG. 9G is a perspective view of building wall 910 with three overclad panels 900A, 900B, 900C and a window 950 installed. FIG. 9H is a perspective view of building wall 910 with four overclad panels 900A, 900B, 900C, 900D installed. FIG. 9I is a perspective view of building wall 910 with five overclad panels 900A, 900B, 900C, 900D, 900E installed. FIG. 9J is a perspective view of building wall 910 with six overclad panels 900A, 900B, 900C, 900D, 900E, 900F installed.

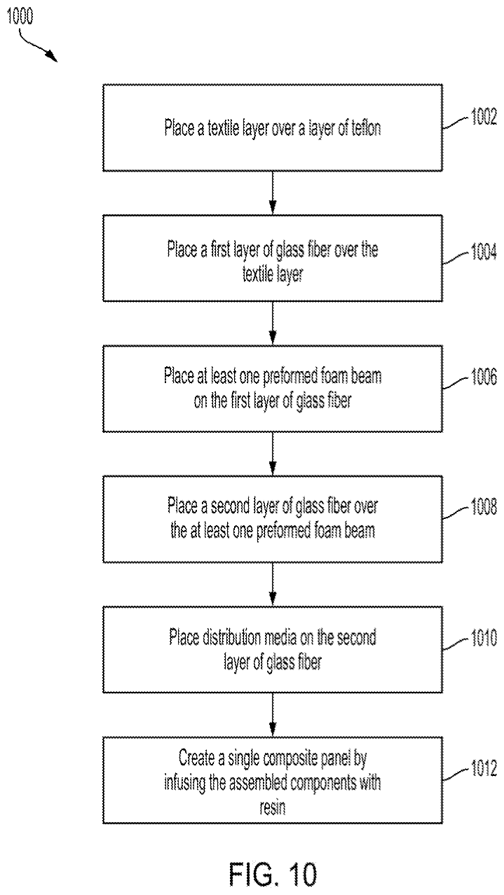

FIG. 10 is a flowchart depicting an example method 1000 for constructing a overclad panel (e.g., overclad panel 100, 200, 300, 400, 500, 600, 700, 800, 900). At step 1002, method 1000 may include placing a textile layer over a layer of an air/water barrier (e.g., Teflon or others as described above). As described above, the textile layer can be an aesthetic textile to provide a particular outward appearance of the overclad panel. At step 1004, a first glass fiber layer may be laid over the textile layer. The air/water barrier, textile, and first glass fiber layer can all be dimensioned according to a desired size of the overclad panel.

At step 1006, at least one first foam beam is laid over the first layer of glass fiber. The first foam beam can be a preformed foam beam as described above. In some embodiments, step 1006 can include placing a plurality of first foam beams over the first layer of glass fiber, while some embodiments may include a single foam beam (e.g., in the form of a foam sheet). In some embodiments, the plurality of foam beams can be spaced apart such that opposing second foam beams can be received between the first foam beams. Step 1008 can include placing a second glass fiber layer over the at least one first foam beam. Step 1010 may include placing distribution media on the second glass fiber layer. The distribution media helps distribute resin through the various assembled components during step 1012. Distribution media can take various forms, including an infusion mesh (for example a nylon mesh or woven nylon sheet); a non-woven nylon mat, a distribution foam, or other suitable media.

At step 1012, method 1000 can include infusing the assembled components with resin, such as an epoxy resin. The infusing can include using a vacuum assisted resin transfer molding (“VARTM”) process. The VARTM process can include placing the assembled components (e.g., the air/water barrier, textile, first and second glass fiber layers, foam beam, and distribution media) into a vacuum bag or other vacuum chamber. A vacuum is applied to the vacuum bag and resin is introduced into the bag via, for example, a feed tube and is drawn by the vacuum through the various layers of the assembled panel. The resin infuses the various layers and fuses them together, creating a composite panel. In some embodiments, the resin may be cured using a heat source such as an oven. This process of assembling a panel can be used to create a full panel by, for example, placing a second air/water barrier on the backside of the panel outside of the second glass fiber layer. In cases where a full panel is created, foam beams may be laid side by with no gap or a relatively small gap between them. In other embodiments, this process may be used to create a half-panel. In such cases, foam beams can be placed on the first glass fiber layer with spaces between them. The spaces can be sized to receive opposing foam beams of a second half-panel. Accordingly, at step 1012, method 1000 can further include placing at least one second foam beam on a third glass fiber layer; placing a fourth glass fiber layer over the second foam beam; placing distribution media on the fourth glass fiber layer; and infusing the third glass fiber layer, fourth glass fiber layer, and second foam beam with resin to create a second half-panel. The two half-panels can then be connecting together to form a composite panel. The two half-panels can be adhered together using an adhesive, such as a polyurethane adhesive or other suitable adhesive.

It will be understood that terms such as “same,” “equal,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to emphasize this meaning, unless the context or other statements clearly indicate otherwise. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances. The term “substantially” may be used to encompass this meaning, especially when such variations do not materially alter functionality.

It will be understood that various modifications may be made to the embodiments disclosed herein. Likewise, the above disclosed methods may be performed according to an alternate sequence. Therefore, the above description should not be construed as limiting, but merely as exemplification of the various embodiments. Those skilled in the art will envision other modifications within the scope and spirit of the claims appended hereto.

What is claimed is:

1. An overclad panel comprising:
a first fiber sheet;
a second fiber sheet; and
a plurality of foam beams arranged parallel to one another and disposed between the first fiber sheet and the second fiber sheet.

2. The overclad panel of claim 1 further comprising a textile layer wherein:
the plurality of foam beams contact a first surface of the first fiber sheet; and
the textile layer is disposed on a second surface of the first fiber sheet.

3. The overclad panel of claim 1 further comprising a barrier layer disposed on a surface of at least one of the first fiber sheet or the second fiber sheet.

4. The overclad panel of claim 1, wherein the first fiber sheet, second fiber sheet, and plurality of foam beams are bonded together with resin.

5. The overclad panel of claim 4, wherein the first fiber sheet, second fiber sheet, and plurality of foam beams are bonded using vacuum assisted resin transfer molding.

6. The overclad panel of claim 1 further comprising an intumescent material.

7. The overclad wall panel of claim 1, further comprising two or more blocks that interleave with each other, each of the two or more blocks comprising at least one of the foam beams.

8. The overclad panel of claim 1, wherein the plurality of foam beams comprise:
a first set of trapezoidal cross-section foam beams arranged parallel to each other such that their respective wider bases are in contact to the first fiber sheet and their respective narrower bases are in contact to the second fiber sheet, and
a second set of trapezoidal cross-section foam beams arranged parallel to each other such that their respective wider bases are in contact to the second fiber sheet and their respective narrower bases are in contact to the first fiber sheet, wherein the trapezoidal cross-section foam beams of the second set are nested between the trapezoidal cross-section foam beams of the first set such that side surfaces of the trapezoidal cross-section foam beams of the second set are in contact with side surfaces of the trapezoidal cross-section foam beams of the first set.

9. An overclad panel system comprising:
two or more panels, each panel comprising
a first fiber sheet and a second fiber sheet, and
at least one foam beam; and
panel-to-building connections configured to couple the panels to a building wall, wherein each panel-to-building connection comprise:
a first panel-to-building connector having a panel cleat disposed on a surface of an associated panel that is to face the building wall, and
a second panel-to-building connector having a wall cleat configured to be disposed on the building wall and arranged relative to the panel cleat to engage with the panel cleat.

10. The overclad panel system of claim 9, wherein the at least one foam beam further comprises:
a first set of trapezoidal cross-section foam beams arranged parallel to each other such that their respective wider bases are in contact to the first fiber sheet and their respective narrower bases are in contact to the second fiber sheet, and
a second set of trapezoidal cross-section foam beams arranged parallel to each other such that their respective wider bases are in contact to the second fiber sheet and their respective narrower bases are in contact to the first fiber sheet, wherein the trapezoidal cross-section foam beams of the second set are nested between the trapezoidal cross-section foam beams of the first set such that side surfaces of the trapezoidal cross-section foam beams of the second set are in contact with side surfaces of the trapezoidal cross-section foam beams of the first set.

11. The overclad panel system of claim 9, further comprising:
panel-to-panel connections configured to couple panels along a common edge when the panels are coupled to the building wall, wherein each panel-to-panel connection comprises:
a first panel-to-panel connector having a protrusion disposed on the common edge of one of an associated pair of panels, and
a second panel-to-panel connector having a groove disposed on the common edge of the other one of the associated pair of panels configured to engage the protrusion.

12. The overclad panel system of claim 11, wherein the first and second panel-to-panel connectors comprise fiber reinforced polymer components.

13. The overclad panel system of claim 11, wherein the fiber reinforced polymer components are formed into their respective panels.

14. The overclad panel system of claim 9, wherein the first and second panel-to-building connectors comprise fiber reinforced polymer components.

15. The overclad panel system of claim 9, wherein the first panel-to-building connector is fastened to the associated panel.

16. The overclad panel system of claim 9, wherein the second panel-to-building connector is fastened to the building wall.

17. The overclad panel system of claim 9, wherein at least one of the two or more panels further comprises a window aperture.

18. The overclad panel system of claim 17 further comprising:
a window comprising a frame; and
a window-to-panel connection comprising:
a first window-to-panel connector comprising window frame cleat disposed on the frame; and
a second window-to-panel connector comprising panel window cleat disposed within the aperture;
wherein the window frame cleat is configured to engage the panel window cleat to secure the window within the aperture.

19. A method of constructing an overclad panel comprising:
placing at least one first foam beam on a first fiber layer;
placing a second fiber layer over the first foam beam;
placing distribution media on the second fiber layer; and
infusing the first fiber layer, second fiber layer, and first foam beam with resin.

20. The method of claim 19 further comprising:
placing at least second foam beam on a third fiber layer;
placing a fourth fiber layer over the second foam beam;
placing distribution media on the fourth fiber layer;
infusing the third fiber layer, fourth fiber layer, and second foam beam with resin; and
adhering the resin infused first fiber layer, second fiber layer, and first foam beam to the resin infused third fiber layer, fourth fiber layer, and second foam beam to form a composite panel.
